(19) United States
(12) Patent Application Publication
(10) Pub. No.: US 2026/0300468 A1
(43) Pub. Date: Oct. 1, 2026

(54) SECURE DEVICE REGISTRATION

(71) Applicant: Lenovo (United States) Inc., Morrisville, NC (US)

(72) Inventors: Irene Nunziata, Allen Park, MI (US); Igor Stolbikov, Apex, NC (US); Rafael Rodrigues Machado, Sorocaba (BR); Scott Li, Cary, NC (US)

(21) Appl. No.: 19/095,823

(22) Filed: Mar. 31, 2025

(51) Int. Cl. G06F 21/44

(52) U.S. Cl. CPC G06F 21/44

(57) ABSTRACT

One embodiment provides a method, the method including: receiving, from a device of a user, a request to register a second device with a computing system, wherein the second device includes at least one post-quantum cryptography key corresponding to the computing system; generating, at the computing system, a registration token for the second device, wherein the registration token includes a random string of characters and is encapsulated using at least one post-quantum cryptography key corresponding to the second device; transmitting, from the computing system, the registration token to the device of the user, wherein the device of the user transmits the registration token to the second device; and validating, at the computing system, a registration response received at the computing system from the device of the user, wherein the registration response is generated by the second device and transmitted to the device of the user.

### BACKGROUND

Device registration is the process of allowing a device access to resources and services of a computing system. Specifically, when a device is registered with the computing system, the device is allowed privileges that are related to the computing system. The device registration is a process by which the device is identified and verified as a device that is authorized to access the computing system. Additionally, during the device registration process, a user is typically associated with the device and the user is provided an account on the computing system. Once a device is registered with the computing system, the user is provided access to the computing system and resources on the computing system, to the extent the user is authorized to access the resources. For example, a user may register a device with a computing system associated with an employer in order to access work related resources. The device registration provides an extra layer of security to ensure only those individuals who are authorized or expected to access the computing system are able to access the computing system.

### BRIEF SUMMARY

In summary, one aspect provides a method, the method including: receiving, from a device of a user, a request to register a second device with a computing system, wherein the second device includes at least one post-quantum cryptography key corresponding to the computing system; generating, at the computing system, a registration token for the second device, wherein the registration token includes a random string of characters and is encapsulated using at least one post-quantum cryptography key corresponding to the second device; transmitting, from the computing system, the registration token to the device of the user, wherein the device of the user transmits the registration token to the second device; and validating, at the computing system, a registration response received at the computing system from the device of the user, wherein the registration response is generated by the second device and transmitted to the device of the user.

Another aspect provides a system, the system including: a processor; a memory device that stores instructions that, when executed by the processor, causes the system to: receive, from a device of a user, a request to register a second device with a computing system, wherein the second device includes at least one post-quantum cryptography key corresponding to the computing system; generate, at the computing system, a registration token for the second device, wherein the registration token includes a random string of characters and is encapsulated using at least one post-quantum cryptography key corresponding to the second device; transmit, from the computing system, the registration token to the device of the user, wherein the device of the user transmits the registration token to the second device; and validate, at the computing system, a registration response received at the computing system from the device of the user, wherein the registration response is generated by the second device and transmitted to the device of the user.

A further aspect provides a product, the product including: a computer-readable storage device that stores executable code that, when executed by a processor, causes the product to: receive, from a device of a user, a request to register a second device with a computing system, wherein the second device includes at least one post-quantum cryptography key corresponding to the computing system; generate, at the computing system, a registration token for the second device, wherein the registration token includes a random string of characters and is encapsulated using at least one post-quantum cryptography key corresponding to the second device; transmit, from the computing system, the registration token to the device of the user, wherein the device of the user transmits the registration token to the second device; and validate, at the computing system, a registration response received at the computing system from the device of the user, wherein the registration response is generated by the second device and transmitted to the device of the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for registering a device with a computing system utilizing post-quantum cryptography to generate registration tokens and validate the registration tokens to validate a request to register the device.

### DETAILED DESCRIPTION

Since computing systems may have resources or systems that the entity controlling or hosting the computing system does not want unauthorized individuals to access, unauthorized individuals may attempt to access these computing systems. However, the device registration process attempts to ensure that only authorized individuals are accessing the computing system. In this process, the user registers a device with the computing system, where the user of the device is authenticated before the device is registered. Based upon the fact that the user is authenticated as an authorized user, the computing system has a level of trust that the device the user is attempting to register should be an authorized device. In order to register the device, the device and computing system exchange information so that the computing system can verify the device.

Traditionally, some of the information that is exchanged is identifiers of the device, for example, device identifiers, device serial numbers, device types, device manufacturer, and/or any other information that may be utilized to specifically identify that device. Additionally, in traditional device registration systems, the device and computing device exchange cryptographic keys. These keys have traditionally been public/private key cryptography, for example, the Rivest, Shamir, and Adleman (RSA) cryptography system, the elliptic curve cryptography (ECC) system, and/or the like. However, quantum computers have immense processing power and have the potential to break these traditional public/private key cryptography techniques. If such techniques are broken for device registration, then unauthorized users or entities could access the computing system, leading to a security breach.

Accordingly, the described system and method provides a technique for registering a device with a computing system utilizing post-quantum cryptography to generate registration tokens and validate the registration tokens to validate a request to register the device. The device registration system receives, from a device of a user, a request to register a second device with a computing system. The request is received at the computing system of the device registration system. During manufacture, the second device and the computing system may have exchanged post-quantum cryptography keys. Accordingly, the second device may have stored at least one post-quantum cryptography key corresponding to the computing system, for example, a public post-quantum cryptography key of the computing system. Similarly, the computing system may have stored at least one post-quantum cryptography key corresponding to the second device, for example, a public post-quantum cryptography key of the second device.

In response to the registration request, the computing system generates a registration token for the second device. The registration token may be calculated as a random number and then encapsulated using the post-quantum cryptography key that corresponds to the second device. The registration token is then transmitted, from the computing system, to the device of the user. The device of the user then transmits the registration token to the second device. The second device generates a registration response based upon the registration token. The registration response is provided to the device of the user. The device of the user transmits the registration response to the computing system. The computing system then validates the registration response. The validation may be performed by decapsulating the registration response and comparing it to a value generated or computed by the computing system. If validated, the second device is registered with the computing system. If not validated, the computing system does not register the second device.

Post-quantum encryption or, more generally, post-quantum, cryptography, (e.g., quantum-resistant cryptography) pertains to cryptographic systems that aim to be secure against quantum and classical computers, which may still provide for interoperation with existing communications protocols and networks.

Therefore, a system provides a technical improvement over traditional methods for device registration. The described system provides an improvement to the encryption technological field, and, specifically, the device registration using cryptology technology field. The described system employs post-quantum cryptography in order to ensure that a device registration request is valid and that the device being registered and, thereafter, allowed access to the computing system is a verified device, thereby mitigating severe security breaches. The advancement of quantum computing poses a threat to traditional cryptographic methods. The described system, on the other hand, is resistant to the capabilities of quantum computers, thereby ensuring continued security and integrity of computing system. Accordingly, the described system provides a significant improvement to the device registration technology field and helps to solve a necessarily computer problem related to security in a device registration process that is necessarily performed using computing systems.

The illustrated example embodiments will be best understood by reference to the figures. The following description is intended only by way of example, and simply illustrates certain example embodiments.

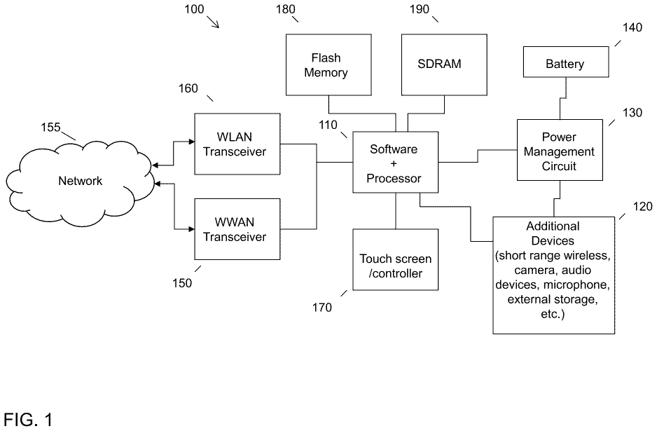

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

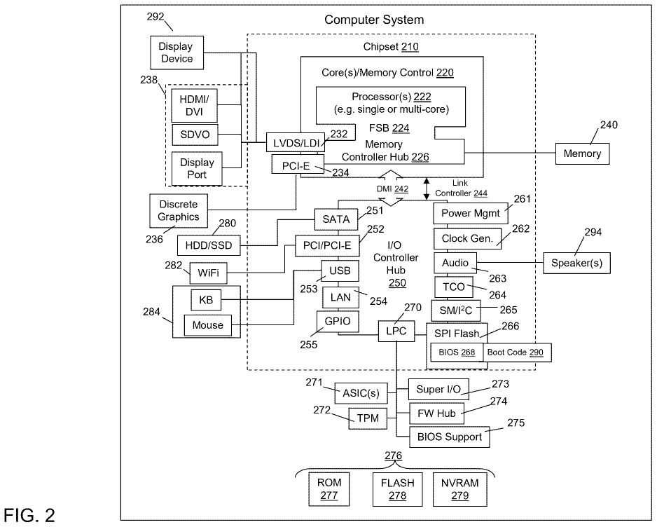

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support. As an example, a TPM may operate to perform one or more cryptographic functions. For example, a TPM may operate as a secure cryptoprocessor that implements the ISO/IEC 11889 standard. As an example, a TPM may provide for generation of one or more cryptographic keys (e.g., consider RSA key generation) and may provide for wrapping or binding of a key, which may help protect a key from disclosure. As an example, a TPM may provide for performing hashing (e.g., consider an SHA-256 hash generator, etc.) and, for example, one or more related functions.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that are used within or used to communicate with the device registration system, devices that house or provide access to the device registration system, and/or the like. For example, the circuitry outlined in FIG. 1 may be implemented in a tablet or smart phone embodiment, whereas the circuitry outlined in FIG. 2 may be implemented in a personal computer embodiment.

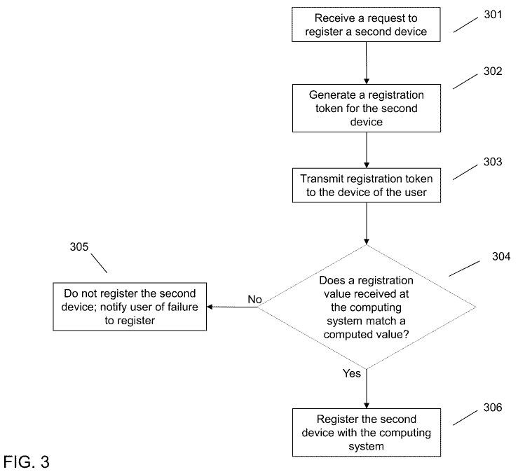

FIG. 3 illustrates an example method for registering a device with a computing system utilizing post-quantum cryptography to generate registration tokens and validate the registration tokens to validate a request to register the device. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to register a device with a computing system. Additionally, the device registration system includes modules and features that are unique to the described system.

The device registration system may be activated in order to register a device, referred to as the second device, with a computing system, thereby allowing the device to access systems and processes of the computing system. The described system utilizes post-quantum cryptography to create a more secure device registration process that is more resilient to quantum computing attacks. The system exchanges registration tokens and registration responses between a device of a user, the second device, and computing system. The exchange utilizes post-quantum cryptography in order to make it more secure. For ease of readability, the second device will be referred to as a new device, the computing system will be referred to as a cloud system, and the device of the user will be referred to as a mobile device. However, these are not intended to be limiting, as any type of device may be registered, any type of computing system may be a system that is attempting to be accessed, and the device of the user can be any type of device (e.g., laptop, tablet, smart phone, smart appliance, virtual or augmented reality system, personal computer, etc.).

Activation of the device registration system may be a manual activation of the device registration system and/or an automatic activation of the device registration system. Manual activation of the system may include a user opening an application associated with the device registration system, the user accessing the computing system associated with the device registration system, and/or the user otherwise providing input to the device registration system. The automatic activation of the device registration system may be based upon the detection of a trigger event indicating that the system should be activated. Example trigger events include detection of a new device attempting to access the cloud system, authorization of a user at an identity management system with a new device, a user accessing an application that interfaces with the device registration system, activation of software or an application utilizing the device registration system, and/or the like.

The device registration system may be made of multiple systems or modules that communicate together to make up the device registration system or may be a single system. The device registration system may be a standalone system, may be accessible through other computing devices, and/or a combination thereof. For example, the device registration system may be a standalone system that can be accessed by a user and/or may be or provide an application that is accessible by a user on another computing device. The device registration system may be accessible using any type of computing device, for example, personal computer, laptop computer, smartphone, tablet, smartwatch, head-mounted display, smart television or other smart appliance, augmented reality device, virtual reality device, and/or the like.

Thus, the device registration system may be accessible locally using a computing device where the device registration system is installed and/or may be accessible remotely through another computing device. For example, the device registration system may be accessed by a user using a mobile device that communicates with the device registration system to register a new device with the cloud system, as a cloud system, as a new device, establish a relationship between the new device and the cloud system during manufacture, and/or the like. However, the device registration system may be located and operate on a different information handling device to perform the described steps.

The device registration system may include different components for carrying out different functions of the system, including different steps to be performed. These components may be hardware components or software components. Some hardware devices or components that may be utilized by the device registration system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the device registration system. For example, the device registration system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the device registration system, and/or the like.

One software component may include a data storage location or data repository that stores information related to devices that are registered with the computing system, authentication information, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by second device, grouped by computing system, grouped by users, grouped by devices of users, and/or the like.

For ease of readability, there will be three devices that are discussed, a device of a user, a second device, and a computing system. For ease of readability, the device of a user will be referred to as a mobile device, the second device will be referred to as the new device, and the computing system will be referred to as a cloud system or device management system. However, it should be noted that more than three devices can be utilized. For example, there may be more than one mobile device, more than one cloud system, more than one new device, and/or the like.

Additionally, it is described that the mobile device will communicate with both the new device and the cloud system. In other words, the mobile device will be used to initiate the registration of the new device with the cloud system and will also be used as an intermediary device to communicate information between the cloud system and the new device. However, there could be additional intermediary devices. For example, the mobile device may communicate with another device that communicates directly with the cloud system. In order to establish that the user of the mobile device is authorized to register a new device with the cloud system, the user of the mobile device may need to be authenticated. In other words, an identity of the user may need to be established and the identity that is identified may need to be identified as belonging to a user that is authorized to register new devices with the cloud system.

Accordingly, the mobile device may communicate with an identity verification system that establishes an identity of the user and then determines if the user is authorized to register new devices with the cloud system. When the user accesses the device registration system to register a new device, the user may provide authentication information (e.g., credentials, two-factor authentication, biometric information, etc.) to the mobile device, for example, via a graphical user interface associated with the device registration system, via an application associated with the device registration system, and/or the like.

This authentication information is transmitted from the mobile device to an identity management system. The identity management system compares the authentication information with known authentication information corresponding to the user. The identity management system may also determine an authorization of the user, for example, whether the user has the authorization to register a new device with the computing system. The identity management system may perform the authorization of the user before or after the identity management system compares the authentication information. If the authentication information matches the known authentication information for the user and the user is authorized to register a new device with the computing system, the identity management system may authenticate the user with respect to the device registration system, thereby allowing the user to continue the new device registration process. Thus, a trust connection is established between the mobile device and the cloud system, thereby allowing the mobile device to communicate with the cloud system and transfer information therebetween.

During manufacture, the new device is in communication with the cloud system. The cloud system has at least one public post-quantum cryptography key that is embedded in the new device during the manufacturing process of the new device. In other words, at least one post-quantum cryptography key corresponding to the computing system is embedded within the second device. While a public post-quantum cryptography key of the cloud system will be used as the example here throughout, it should be noted that other types and/or numbers of post-quantum cryptography keys of the computing system may be established with or embedded with the second device.

Additionally, the new device, during the manufacturing process, generates at least one post-quantum cryptography key to be sent to the computing system. This key, or keys, is transmitted to the computing system. In other words, the second device generates at least one post-quantum cryptography key corresponding to the second device and transmits the at least one post-quantum cryptography key corresponding to the second device to the computing system. Thus, the at least one post-quantum cryptography key corresponding to the computing system and the at least one post-quantum cryptography key corresponding to the second device are exchanged between the second device and the cloud system during a manufacture of the second device. It should be noted that the keys that are exchanged may be public keys of a key pair and the corresponding device keeps the private key of the key pair. For example, the new device would transmit the public key of the post-quantum cryptography key pair of the new device to the cloud system and keep the private key of the post-quantum cryptography key pair of the new device at the new device. In addition to the post-quantum cryptography key pairs, traditional key pairs may be generated and used in the hybrid traditional plus post-quantum schemas, for example, ECC plus ML-DSA, ECC plug ML-KEM, RSA plus ML-DSA, and/or the like.

The key generation may be performed by generating private and public keys from a common secure seed value, which may be a device composite identity, physically unclonable function (PUF), and/or the like. The keys may be augmented with unique randomness to make them more secure and less prone to being guessed or derived, even if device identity information is known. The keys that may be generated may include module lattice-based encapsulation public and private key pairs, elliptic curve keys, module lattice-based signature public and private key pairs, elliptic curve key signing keys, and/or the like. While these examples are utilized, it should be noted that other types of keys can be generated, for example, any type of encapsulation public and private key pair, a traditional public key, a public and private key pair for device signatures, signing keys, and/or the like. The keys that are generated are non-deterministic keys and are not guessable keys.

In addition to the at least one post-quantum cryptography key corresponding to the second device, the new device transmits device identifiers to the cloud system, for example, a serial number of the new device, an identifier of the new device, a type of the new device, a manufacturer of the new device, a model of the new device, and/or any other identifying information. The cloud system, or device management system, maintains a record of the public keys of new devices and the identifying information for the new device.

At 301, the device registration system may receive a request to register a second device with a computing system. In other words, the device registration system may receive a request to register a new device with a cloud system. The request may be received from the device of the user, or mobile device, at the cloud system. In other words, the request, also referred to a registration request, may be received at the cloud system of the device registration system. The receipt of the request may be in response to authenticating the user at the identity management system. In other words, unless the user is authenticated at the identity management system, the cloud system may not process a registration request. Receipt of the request may include the user initiating the device registration process with the cloud system.

The initiation of the device registration process include identifying the new device that is to be registered with the cloud system. The identification information that is transmitted to the cloud system may be any of or all of the identifying information for the new device that can be compared against the identifying information for new devices that is stored at the cloud system. Thus, the identifying information that is transmitted needs to be enough identifying information that can uniquely identify the new device from other new device identifying information that may be stored at the cloud system. In other words, the identifying information that is transmitted could not simply be a make and model of the new device, as there is likely more than one device that has the same identifying information. On the other hand, serial numbers may be more unique identifiers and may not require as much identifying information in order to identify at the cloud system. The amount of identifying information that is required to identify the new device may be based upon a number of devices stored with the cloud system, may be a default amount of information, may be set by an entity that supports or corresponds to the cloud system, and/or the like.

The initiation of the registration process may include a request for a registration token from the cloud system. Accordingly, at 302, the computing system generates a registration token for the second device. In other words, the cloud system generates a registration token that corresponds to the new device and that can be used to register the new device with the cloud system. To generate the registration token, the cloud system may generate a random number or random string of characters (e.g., numbers, letters, symbols, etc.). The length of the random string may be set by the system, with longer lengths being more desirable because they are harder to guess. However, the string length may be of any length. The random string of characters is then encapsulated by the computing system using at least one post-quantum cryptography key corresponding to the second device.

Using the example keys discussed before, the random string of characters is encapsulated by the cloud system using the public key of the post-quantum cryptography key of the new device. Thus, the cloud system utilizes the identifying information of the device to retrieve the key corresponding to the new device. Accordingly, the at least one post-quantum cryptography key corresponding to the second device and that was transmitted to the cloud system during the manufacture of the new device, is used by the computing system during this generation of the registration token. The random string of characters may be stored in the cloud system for a limited period of time, for example, an average length of time that a device registration process works, a set length of time, and/or the like. After expiration of the time period, the random string of characters may be deleted from the cloud system.

At 303, the registration token is transmitted from the cloud system to the mobile device. In other words, the computing system transmits the generated registration token to the device of the user. The device of the user, or mobile device, transmits the registration token to the new device. Thus, in this instance, the mobile device may act as an intermediary or passthrough to get the registration token that was generated by the cloud system to the new device since the new device and the cloud device are not in direct communication with each other. Thus, during the device registration process, the new device and cloud device do not directly communicate with each other. However, during the manufacturing process for the new device, the cloud device and the new device are in operative communication with each other in order to exchange keys. This operative communication may occur directly between the new device and the cloud system or may occur through an intermediary system.

The new device generates a registration value based upon the receipt of the registration token. Since the registration token is encapsulated, the new device decapsulates the registration token using the post-quantum cryptography key that is paired with the key that was used to encapsulate the registration token. Using the example above, the new device would decapsulate the registration token using the private post-quantum cryptography key of the new device. The new device then calculates the registration value. The registration value may be calculated or generated based upon encryption keys of the new device and the cloud system. For example, the registration value may be generated based upon a private key of the device, which may be a traditional encryption key as opposed to a post-quantum encryption key, and a public key of the cloud system, which may also be a traditional encryption key as opposed to a post-quantum encryption key.

The registration value may also be calculated or generated based upon other information, for example, device attributes, user authentication attributes, a timestamp, and/or the like. The timestamp may be a timestamp associated with the generation of the random string of characters, may be a timestamp associated with the transmission of the registration token from the mobile device to the new device, may be a timestamp associated with a receipt of the registration request, and/or the like. Thus, in the case in addition to the registration value, the mobile device may also transmit a timestamp to the new device, with the timestamp being the correct timestamp for the computation. The generated registration value is then encapsulated using the at least one post-quantum cryptography key corresponding to the computing system and stored by the second device. For example, the public post-quantum cryptography key of the cloud and stored by the new device may be used to encapsulate the registration response value. The encapsulated registration value is then transmitted to the device of the user, or the mobile device.

The encapsulated registration value, also referred to as the registration response, is transmitted from the mobile device to the cloud system. The cloud device then validates the registration response in order to determine if the new device should be registered with the cloud system. Thus, at 304, the device registration system determines if the registration value received at the computing system matches a value that is computed at the computing system. In other words, the computing system validates the registration response received at the computing system from the device of the user. To perform the validation, the computing system decapsulates the registration response utilizing the key corresponding to the key pair used to encapsulate the registration response. Using the example above, the registration response is decapsulated using the private post-quantum cryptography key of the cloud system.

The cloud system then generates or computes a value that can be compared to the registration value generated by the new device. In other words, the cloud system generates a comparison value that is compared to the registration value. To generate the comparison value, the cloud system performs a similar calculation that was performed by the new device to generate the registration value. In order to compute the comparison value, the same (or corresponding) information has to be used by the cloud system as that was used by the new device. In other words, and for example, if the new device used timestamp information, then the cloud system also needs the timestamp information. Accordingly, the mobile device may, if needed, transmit timestamp information to the cloud system that matches the timestamp information transmitted to the new device. As another example, if the registration value was based upon user authentication attributes, then these same user authentication attributes will be used by the cloud system in computing the comparison value.

Thus, for example, the comparison value may be generated based upon encryption keys of the new device and the cloud system. Since the cloud system would have access to the corresponding key from the key pair used by the new device, then the encryption keys used by the cloud system may be the corresponding keys. Using the example used for generating the registration value, the comparison value may be generated based upon a public key (as opposed to the private key) of the device, which may be a traditional encryption key as opposed to a post-quantum encryption key, and a private key (as opposed to the public key) of the cloud system, which may also be a traditional encryption key as opposed to a post-quantum encryption key.

As mentioned, the comparison value may also be calculated or generated based upon other information that was used by the new device for generation of the registration value, for example, device attributes, user authentication attributes, a timestamp, and/or the like. Once the comparison value is generated, the cloud system can compare the comparison value to the registration value. This comparison is the validation performed at 304.

If the registration value does not match the comparison value at 304, then the computing system does not register the second device at the computing system at 305. In other words, responsive to an unsuccessful validation of the registration response at 304, the computing system may fail to register the second device with the computing system at 305. The device registration system may also notify the user of the failure to register the device. The notification may be a pop-up notification, may be a change in the state of an icon associated with the new device (e.g., change in an outline of an icon, change in a color of an icon, change in a graphic of the icon, etc.), may be an audible notification, may be a haptic notification, and/or the like, or a combination thereof, with the notification corresponding to a failure.

If, on the other hand, the registration value does match the comparison value at 304, then the computing system may register the second device with the computing system at 306. In other words, responsive to a successful validation of the registration response at 304, the computing system may register the second device with the computing system. Additionally, the device registration system may notify the user of the successful registration of the new device at the cloud system. This notification may be any of the previously mentioned notification types, with the notification corresponding to a success instead of a failure.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, from a device of a user, a request to register a second device with a computing system, wherein the second device comprises at least one post-quantum cryptography key corresponding to the computing system;
generating, at the computing system, a registration token for the second device, wherein the registration token comprises a random string of characters and is encapsulated using at least one post-quantum cryptography key corresponding to the second device;
transmitting, from the computing system, the registration token to the device of the user, wherein the device of the user transmits the registration token to the second device; and
validating, at the computing system, a registration response received at the computing system from the device of the user, wherein the registration response is generated by the second device and transmitted to the device of the user.

2. The method of claim 1, comprising registering the second device with the computing system responsive to a successful validation of the registration response.

3. The method of claim 1, comprising failing to register the second device with the computing system responsive to an unsuccessful validation of the registration response.

4. The method of claim 1, wherein the second device generates the at least one post-quantum cryptography key corresponding to the second device and transmits the at least one post-quantum cryptography key corresponding to the second device to the computing system for use during the generating.

5. The method of claim 1, wherein the receiving of the request comprises authenticating the user.

6. The method of claim 1, wherein the validating comprises the computing system identifying a registration value by decapsulating the registration response and comparing the registration value with a comparison value generated by the computing system.

7. The method of claim 1, wherein the registration response is encapsulated by the second device using the at least one post-quantum cryptography key corresponding to the computing system.

8. The method of claim 1, wherein the registration response is generated based upon a timestamp corresponding to receipt of the request.

9. The method of claim 1, wherein the at least one post-quantum cryptography key corresponding to the computing system and the at least one post-quantum cryptography key corresponding to the second device are exchanged during a manufacture of the second device.

10. The method of claim 1, wherein the computing system comprises a device management system.

11. A system, the system comprising:
a processor;
a memory device that stores instructions that, when executed by the processor, causes the system to:
receive, from a device of a user, a request to register a second device with a computing system, wherein the second device comprises at least one post-quantum cryptography key corresponding to the computing system;
generate, at the computing system, a registration token for the second device, wherein the registration token comprises a random string of characters and is encapsulated using at least one post-quantum cryptography key corresponding to the second device;
transmit, from the computing system, the registration token to the device of the user, wherein the device of the user transmits the registration token to the second device; and
validate, at the computing system, a registration response received at the computing system from the device of the user, wherein the registration response is generated by the second device and transmitted to the device of the user.

12. The system of claim 11, comprising registering the second device with the computing system responsive to a successful validation of the registration response.

13. The system of claim 11, comprising failing to register the second device with the computing system responsive to an unsuccessful validation of the registration response.

14. The system of claim 11, wherein the second device generates the at least one post-quantum cryptography key corresponding to the second device and transmits the at least one post-quantum cryptography key corresponding to the second device to the computing system for use during the generating.

15. The system of claim 11, wherein the receiving of the request comprises authenticating the user.

16. The system of claim 11, wherein the validating comprises the computing system identifying a registration value by decapsulating the registration response and comparing the registration value with a comparison value generated by the computing system.

17. The system of claim 11, wherein the registration response is encapsulated by the second device using the at least one post-quantum cryptography key corresponding to the computing system.

18. The system of claim 11, wherein the registration response is generated based upon a timestamp corresponding to receipt of the request.

19. The system of claim 11, wherein the at least one post-quantum cryptography key corresponding to the computing system and the at least one post-quantum cryptography key corresponding to the second device are exchanged during a manufacture of the second device.

20. A product, the product comprising:
a computer-readable storage device that stores executable code that, when executed by a processor, causes the product to:
receive, from a device of a user, a request to register a second device with a computing system, wherein the second device comprises at least one post-quantum cryptography key corresponding to the computing system;
generate, at the computing system, a registration token for the second device, wherein the registration token comprises a random string of characters and is encapsulated using at least one post-quantum cryptography key corresponding to the second device;
transmit, from the computing system, the registration token to the device of the user, wherein the device of the user transmits the registration token to the second device; and
validate, at the computing system, a registration response received at the computing system from the device of the user, wherein the registration response is generated by the second device and transmitted to the device of the user.
